(19) United States
(12) Patent Application Publication
(10) Pub. No.: US 2009/0050187 A1
(43) Pub. Date: Feb. 26, 2009

(54) WALKER WITH UNDERARM SUPPORTS

(76) Inventor: Karen Y. Lamb, Westland, MI (US)

Correspondence Address: JOHN D. WRIGHT;Dickinson Wright PLLC, Ste.2000, 38525 Woodward Avenue, Bloomfield Hills, MI, 48304-2970, US

(21) Appl. No.: 12/193,988

(22) Filed: Aug. 19, 2008

Related U.S. Application Data
(60) Provisional application No. 60/965,324, filed on Aug. 20, 2007.

(51) Int. Cl. A61H 3/04

(52) U.S. Cl. 135/67

(57) ABSTRACT

A walker has a plurality of legs each terminating at a free end with rolling members operably attached to at least a pair of the free ends. The rolling members are configured for rolling engagement with a ground surface. The walker further includes a pair of handles configured for gripping by a user's hands while walking and a pair of upright support members that extend upwardly to free ends. The upright support members are configured for engagement with the user's underarms to bear weight of the user and to transfer at least a portion of the user's weight to the rolling members while walking.

### CROSS-REFERENCE TO RELATED APPLICATION

This application claims the benefit of U.S. Provisional Application Ser. No. 60/965,324, filed Aug. 20, 2007, which is incorporated herein by reference in its entirety.

### BACKGROUND OF THE INVENTION

1. Technical Field

This invention relates generally to devices used to assist the mobility of a handicapped person, and more particularly to devices used to assist walking.

2. Related Art

Partial weight bearing devices are known that assist a handicap person in walking. These devices typically have a frame that terminates at the hip level of the user, and can include wheels to assist the device in rolling. In use, the user grips the frame at hip level and places a portion of their weight on the device while walking. As such, the user must lean forward to bear their weight on the device, and thus, their posture is compromised. Accordingly, while walking, their posture assumes an uncomfortable and awkward bent-over position. In addition, the frames typically wrap around the front of the user, thereby impeding the user's free mobility. With the frame being positioned in front of the use, the user's legs can be restricted from their full range of natural walking motion. Further yet, the devices typically require the user to bear a substantial amount of their upper body weight on their hips and legs. This results because the user can only reduce the body weight borne on their hips and legs by pressing downwardly on the frame of the device. As such, as the user becomes tired, or if the user is generally weak, the ability of the user to press down on the frame becomes diminished, thereby resulting in increased weight being placed on the hips and legs of the user. Additionally, known walking devices typically require the user to remain on their feet, unless of course, the user is near a seat. As such, the user may find it difficult to walk significant distances unless seats are located along the path.

### SUMMARY OF THE INVENTION

A walker has a plurality of legs each terminating at a free end with rolling members operably attached to at least a pair of the free ends. The rolling members are configured for rolling engagement with a ground surface. The walker further includes a pair of hand members configured for gripping by a user while walking. A pair of upright support members extend upwardly to free ends configured for engagement with the user's underarms to bear weight of the user and to transfer at least a portion of the user's weight to the rolling members while walking.

### BRIEF DESCRIPTION OF THE DRAWINGS

These and other aspects, features and advantages of the invention will become more readily appreciated when considered in connection with the following detailed description of presently preferred embodiments and best mode, appended claims and accompanying drawings, in which:

FIG. 1 is a perspective view of a walker constructed according to one presently preferred embodiment of the invention with a user shown walking with assistance by the walker;

FIG. 2 is an exploded perspective view of the walker of FIG. 1;

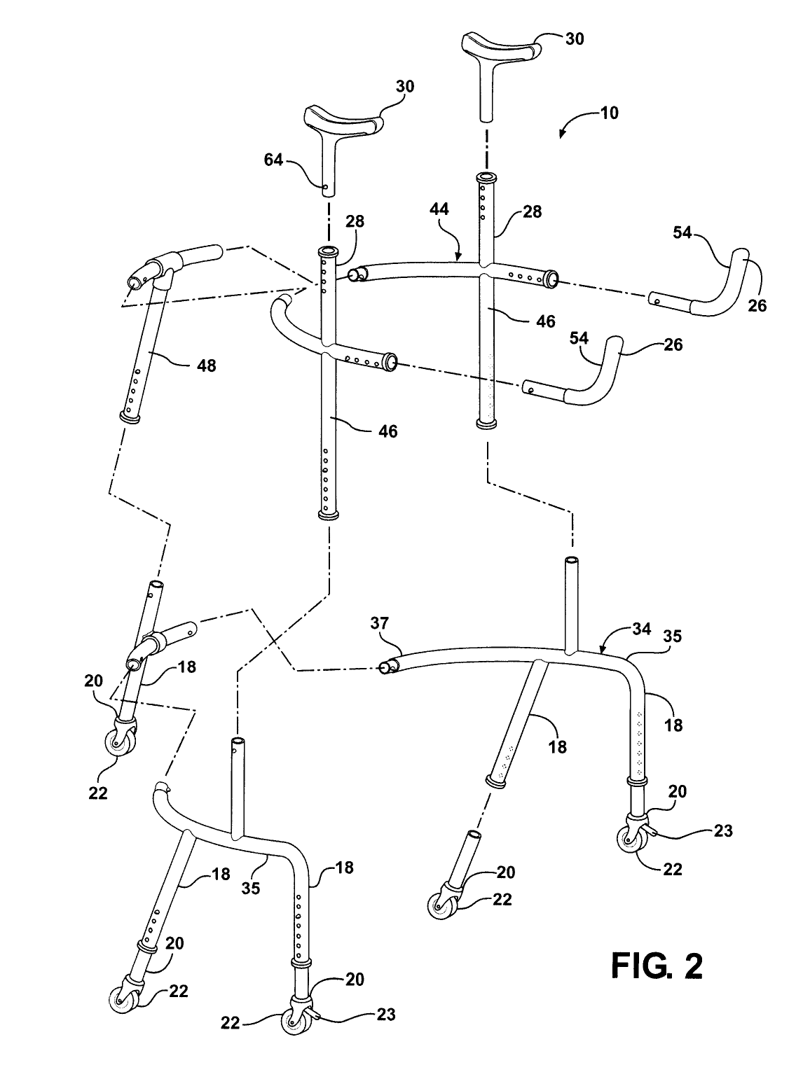

FIG. 3 is an exploded perspective view of an upright member of the walker of FIG. 1; and

FIG. 4 is a perspective view of the walker of FIG. 1 with a seat attached to a frame member of the walker.

### DETAILED DESCRIPTION OF PRESENTLY PREFERRED EMBODIMENTS

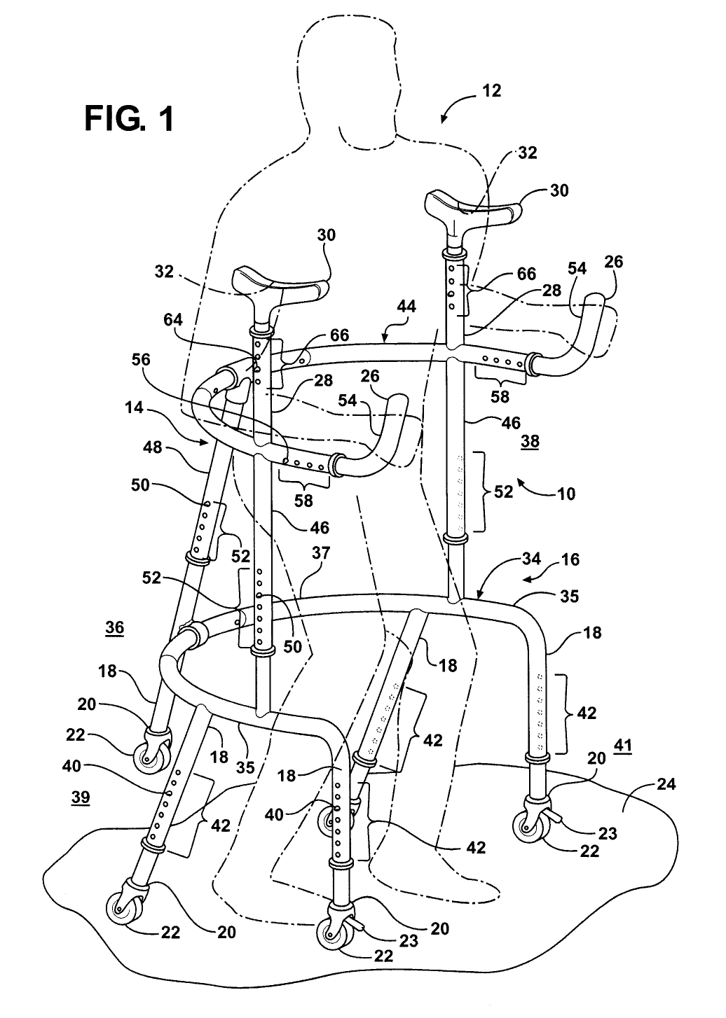

Referring in more detail to the drawings, FIG. 1 illustrates a walker 10 constructed according to one presently preferred embodiment of the invention. The walker 10 assists a handicapped user, shown generally at 12, with an ability to walk in a normal upright posture, while at the same time allowing the user 12 to place a minimal amount of their body weight on their lower body portion, including their hips and legs, shown generally at 14, 16, respectively. In addition, the walker 10 does not obstruct the user's legs 16, thereby providing a full and unobstructed range of leg motion while walking. The walker 10 is also constructed of lightweight materials, such as aluminum and/or high strength plastic, and preferably collapsible to facilitate both ease of use and storage. The walker 12 has a plurality of legs 18 each terminating at a free end 20, with rolling members 22 operably attached to at least a pair of the free ends 20, and shown here as being attached to all the free ends 20, for example. The rolling members 22 are configured for rolling engagement with a ground surface 24, and can also have one or more brakes 23 operable therewith to fix the rolling members in place, thereby preventing them from rolling. In addition, either all or selected rolling members 22 can have a swiveling or pivoting ability to facilitate rolling the walker 10. The walker 10 has a pair of grippable hand members, referred to hereafter as handles 26, configured for gripping by the user 12. Further, the walker 10 has a pair of upright support members, referred to hereafter as supports 28, each extending upwardly generally perpendicular to the ground surface 24 to a free end 30 configured for engagement with underarms 32 of the user 12. During use of the walker 10, the user 12, while walking in a generally normal posture, can bear weight on the walker 10 by engaging their underarms 32 with the free ends 30 of the supports 28, in turn transferring their weight through the legs 18 of the walker to the rolling members 22 engaged with the ground surface 24. Accordingly, the walker 10 functions in a rolling walker, crutch-like capacity, while providing a stable support to the user via the plurality of legs 18 and the pair of supports 28.

The legs 18 extend in a generally vertical orientation in spaced relation to one another, and are shown here, by way of example, as being attached to a base or lower frame member 34. The lower frame member 34 has a generally u-shaped configuration extending generally transverse to the legs 18. As such, the lower frame member 34 has a pair of laterally spaced arms 35 joined by a central portion 37. The closed central portion 37 of the lower frame member 34 faces rearwardly toward a rear 36 of the walker 10, while the arms 35 extend along opposite sides 39, 41 of the walker 10. As such, an open portion of the lower frame member faces forwardly toward a front 38 of the walker 10.

The legs 18 are preferably adjustable in length from the lower frame member 34, wherein the legs 18 are represented here as being adjustable via spring detent fasteners 40. As such, by depressing the spring detent fasteners 40, the individual legs 18 can be moved telescopically to increased or decreased their length, or they can be completely removed to facilitate stowing the walker 10. As such, it should be recognized that the legs 18 have telescopic portions, with one portion having a reduce diameter from the other portion. It should further be recognized that at least the larger diameter portion is tubular for sliding receipt of the reduced diameter portion. Further yet, it should be recognized that one portion of the legs 18 have spaced openings 42, in any suitable spaced relation, such as about 1″, for example, wherein the openings 42 are sized to receive the spring detent fasteners 40. Of course, other fastening mechanisms are contemplated herein for coupling the legs 18 to the lower frame member 34, such as bolts, pins, or any other suitable mechanical fastening mechanism.

The legs 18 are oriented to provide stability to the walker 10, and thus, to the user while bearing weight on the walker. For example, a pair of legs 18 extend downwardly from one arm 35 while another pair of legs 18 extend downwardly from the opposite arm 35. As such, a stable support is provide by the four legs 18 and their corresponding rolling members 22 on the ground surface 24. It should be recognized that the legs 18 are preferably substantially equal in length upon being adjusted, thereby providing sturdy and generally rectangular planar engagement of the rolling members 22 with the ground surface 24. To provide additional stability to the walker 10, and thus, to the user 12, the walker can include additional legs 18 as desired, such as a central leg 18 extending downwardly from the central portion 37 of the lower frame member 34. The central leg 18 can be inclined outwardly from the central portion 37 to further inhibit the walker 10 from being able to tip or lean rewardly. Aside from the central leg 18 having an inclined relation, the remaining legs 18 can be configured in non-parallel diverging relation with one another to further enhance the stability of the walker 10, as desired.

The walker 10 is shown here, by way of example and without limitation, as having an upper frame member 44 generally similar in shape to the lower frame member 34, thereby having a generally u-shaped configuration. The upper frame member 44 extends generally transverse to the legs 18 in vertically spaced and generally mirrored relation to the lower frame member 34. The upper frame member 44 has a pair of laterally spaced arms 45 joined by a central portion 47. The closed central portion 47 of the lower frame member 34 faces rearwardly toward the rear 36 of the walker 10, while the arms 45 extend along the opposite sides 39, 41 of the walker 10. As such, an open portion of the upper frame member 44 faces forwardly toward the front 38 of the walker 10.

The upper frame member 44 is attached to the lower frame member 34 by a plurality of upright supports, wherein a pair of the upright supports 46 extend between the respective arms 35, 45 of the lower and upper frame members 34, 44. In addition, a central upright support 48 extends between the respective central portions 37, 47 of the lower and upper frame members 34, 44. The central upright support 48, by way of example and without limitation, is represented as an extension of the central leg 18, and thus, is shown as being formed at least partially as one piece of material therewith. The upright supports 46, 48 are preferably adjustable in length between the lower and upper frame members 34, 44, such as via spring detent fasteners 50, as discussed above in relation to the legs 18. As such, by depressing the spring detent fasteners 50, the individual upright supports 46, 48 can be moved telescopically to increased or decreased their length, or they can be completely separated to facilitate stowing the walker 10. As such, it should be recognized that the upright supports 46, 48 have telescopic portions, with one portion having a reduce diameter from the other portion, as discussed above in relation to the legs 18. Further yet, it should be recognized that one portion of the upright supports 46, 48 have spaced openings 52, in any suitable spaced relation, such as about 1″, for example. Of course, other fastening mechanisms are contemplated herein, such as bolts, pins, or any other suitable mechanical fastening mechanism.

The handles 26 are represented, by way of example and without limitation, as extending from free ends of the upper frame member arms 45. The handles 26 can be shaped having any desired configuration to facilitate gripping by the user 12, and are shown here as having an arcuate shape, providing a portion being adjustable to extend upwardly to provide a gripping portion 54. The gripping portions 54 can have a cushioning, resilient cover, such as foam or rubber, for example. The handles 26 are preferably adjustable in length, such as via spring detent fasteners 56, as discussed above in relation to the legs 18 and upright supports 46, 48. As such, by depressing the spring detent fasteners 56, the handles 26 can be moved telescopically outwardly or inwardly along a direction generally perpendicular to the upright supports 28 to increase or decrease their length to accommodate varying arm lengths of different users, or they can be completely separated to facilitate stowing the walker 10. As such, it should be recognized that the handles 26 have telescopic portions, with one portion having a reduce diameter from the other portion, as discussed above in relation to the legs 18 and upright supports 46, 48. And so, it should be recognized that one portion of the handles 26 have spaced openings 58, in any suitable spaced relation, such as about 1″, for example. Of course, other fastening mechanisms are contemplated herein, such as bolts, pins, or any other suitable mechanical fastening mechanism.

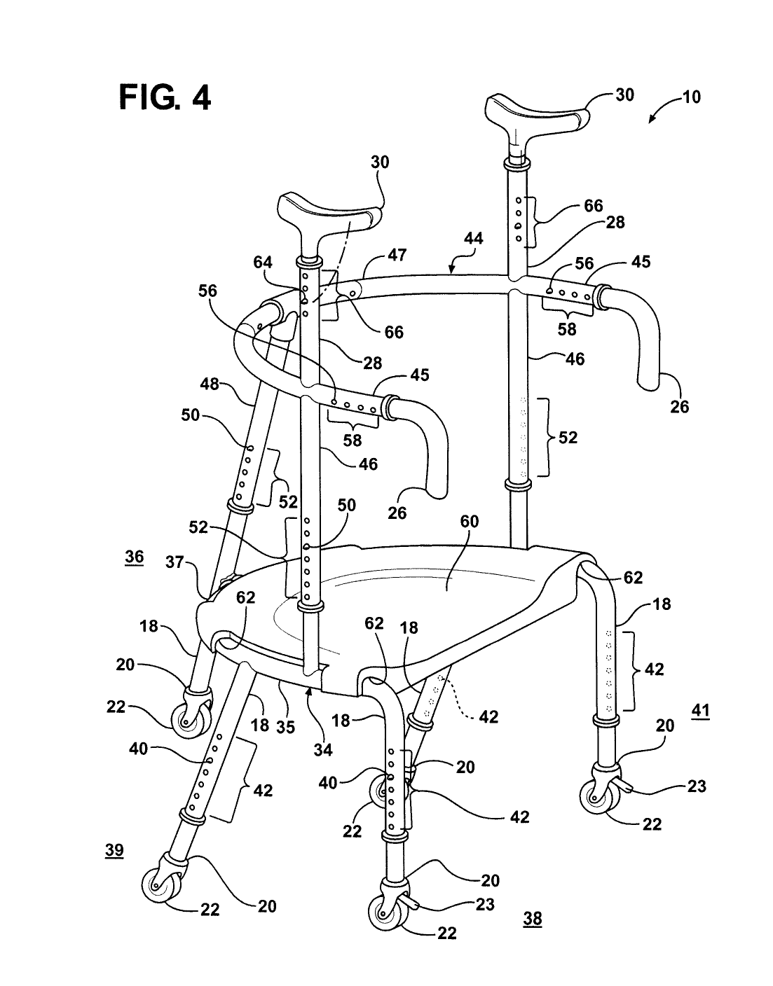

As shown in FIG. 4, a seat 60 an be attached to the walker 10 to allow the user 12 to sit, as desired. The seat 60 can be provided as a rigid member, such as a plastic or metal material, or it could be provided as a fabric material, thereby facilitating stowing while not in use. The seat 60 is removably attached between the free ends 20 of the legs 18 and the free ends 30 of the upright supports 28. The seat 60 is represented here, by way of example and without limitation, as having clips with recessed receptacles 62 along its side edges spaced for clipped receipt or stable engagement with the arms 35 and central portion 37 of the lower frame member 34. Upon being engaged with the lower frame member 34, the seat 60 is maintained in position and prevented from moving relative to the lower frame member 34, until intentionally lifted therefrom. It should be recognized that any suitable mechanism for attaching the seat 60 to the lower frame member 34 could be used, such as spring detents, pins, or hook and loop type mechanisms, for example.

The upright supports 28 are represented as being attached to the arms 45 of the upper frame member 44, and extending coaxially with the upright supports 46, for example. The upright supports 28 are preferably adjustable in length, such as via spring detent fasteners 64, as discussed above in relation to the legs 18, upright supports 46, 48 and handles 26. As such, by depressing the spring detent fasteners 64, the upright supports 28 can be moved telescopically upwardly or downwardly to increase or decrease their height relative to the ground surface 24 to accommodate varying heights of different users, or they can be completely separated to facilitate stowing the walker 10. As such, it should be recognized that the upright supports 28 have telescopic portions, with one portion having a reduce diameter from the other portion, as discussed above in relation to the legs 18, upright supports 46, 48 and handles 26. And so, it should be recognized that one portion of the upright supports 28 have spaced openings 66, in any suitable spaced relation, such as about 1″, for example. Of course, other fastening mechanisms are contemplated herein, such as bolts, pins, or any other suitable mechanical fastening mechanism. In addition, the upright supports 28 can be adjusted widthwise to accommodate different sized users. The width of the upright supports 28 can be adjusted by adjusting the width of the lower and upper frame members 34, 44, respectively. This can be performed via spring detents, as discussed above, wherein the respective arms 35, 45 and central portions 37, 47 can be expanded or retracted in width, thereby increasing or decreasing the lateral distance between the respective arms 35, 45 and also the upright supports 28, as desired.

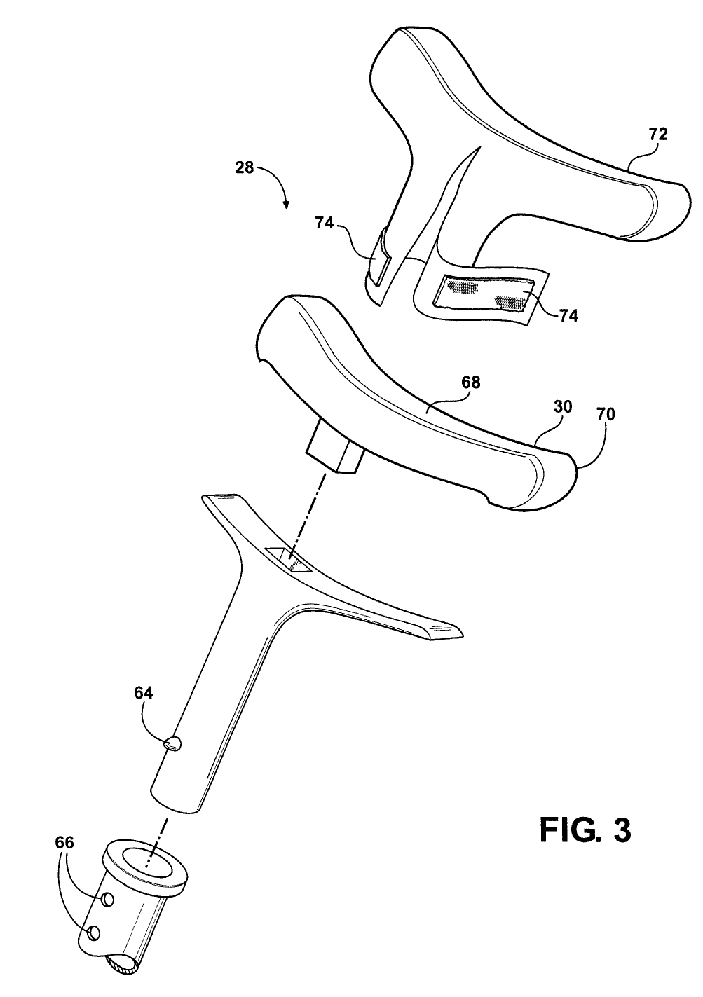

As shown in FIG. 3, the free ends 30 of the upright supports 28 can be provided having a concave surface 68 for engagement with the user's underarms 32. The concave surface 68 can be provided as a resilient cushion member 70, wherein the cushion member can be provided as a gel pack insert, foam cushion, or the like. To protect the cushion member 70 and to extend its useful life, a cover 72 can be disposed thereon, and maintained in position such as via hook and loop fasteners 74, or tie strings, buttons, or some other suitable fastening mechanism. The cover 72 can be fabricated of any suitable weather resistant fabric material, depending on the exposure of the walker to the outdoors.

In use, the user 12 grips the handles 26 to facilitate propelling the walker 10 in the direction of intended motion, while, if desired, places their underarms 32 in engagement with the cushioned free ends 30 of the upright supports 28. Accordingly, the handles 26 and the upright supports 28 combine to provide the user with an ability to walk in a substantially normal, upright walking posture. In addition, the upright supports 28 allow the user 12 to transfer substantially all of their body weight to their underarms 32, if desired, thereby preventing their body weight from being placed on their hips 14 and legs 16. Thus, the walker 10 allows the user to maintain an upright position, although not placing a significant portion of their body weight on their lower body, i.e. hips and legs. As such, the walker 10 is ideal for those needing to keep weight off their lower body while walking. Further, should the user need to rest, the seat 60 can be readily attached, thereby transforming the walker 10 into a portable seat. To prevent the walker 10 from moving, such as when transformed into the seat, for example, the brakes 23 can be deployed by depressing them into engagement with the wheels 22, such as with a foot, for example. When desired, the brakes 23 can be disengaged from contacting the wheels 22 by lifting up on the respective brakes, thereby allowing the wheels 22 to roll freely.

Obviously, many modifications and variations of the present invention are possible in light of the above teachings. It is, therefore, to be understood that within the scope of the appended claims, the invention may be practiced otherwise than as specifically described.

What is claimed is:

1. A walker, comprising:
a plurality of legs each terminating at a free end;
rolling members operably attached to at least a pair of said free ends, said rolling members being configured for rolling engagement with a ground surface;
a pair of handles configured for gripping by a user; and
a pair of upright support members each extending upwardly generally perpendicular to the ground surface to a free end configured for engagement with the user's underarms to bear weight of the user and to transfer at least a portion of the user's weight to said rolling members.

2. The walker of claim 1 wherein said plurality of legs comprise at least three legs.

3. The walker of claim 2 wherein at least one of said plurality of legs or said upright support members is telescopic.

4. The walker of claim 1 further comprising a seat removably attached between said free ends of said plurality of legs and said free ends of said upright support members.

5. The walker of claim 2 wherein a generally u-shaped frame member extends substantially transverse to said legs and said upright support members, said u-shaped frame member closing off a rear side of the walker and being open toward a front side of said walker.

6. The walker of claim 5 wherein said u-shaped frame member is adjustable in width.

7. The walker of claim 1 wherein said free ends of said upright support members have a concave surface for engagement with the user's underarms.

8. The walker of claim 7 wherein said concave surfaces are provided by a pair of resilient cushion members.

9. The walker of claim 1 wherein said legs and said upright support members are detachable to facilitate stowing said walker.

10. The walker of claim 1 wherein said upright support members are adjustable in height.

11. The walker of claim 10 wherein said upright support members are adjustable in width.

12. The walker of claim 10 wherein said handles are adjustable in length along a direction generally perpendicular to the upright support members.
